(19) United States
(12) Patent Application Publication
(10) Pub. No.: US 2025/0130847 A1
(43) Pub. Date: Apr. 24, 2025

(54) MULTIMEDIA DATA PROCESSING METHOD AND SYSTEM, AND DEVICE

(71) Applicant: Beijing Bytedance Network Technology Co., Ltd., Shijingshan District, Beijing (CN)

(72) Inventors: Shaofei WANG, Beijing (CN); Qingyuan ZHANG, Beijing (CN)

(21) Appl. No.: 18/569,893

(22) PCT Filed: Sep. 14, 2022
(86) PCT No.: PCT/CN2022/118790

§ 371 Date: Dec. 13, 2023

(30) Foreign Application Priority Data
Oct. 12, 2021 (CN) 202111188642.5

(51) Int. Cl. G06F 9/48

(52) U.S. Cl. CPC G06F 9/4806

(57) ABSTRACT

A multimedia data processing method includes: when first multimedia data exists in a first input manager of a first processing node, generating a first processing task, the first processing task comprising the first multimedia data; calling the first processing node to execute the first processing task to obtain second multimedia data, the second multimedia data being data obtained by processing the first multimedia data in the first processing task; and writing the second multimedia data into a second input manager of at least one second processing node, the second input manager being an input manager associated with a first output manager of the first processing node. According to the method, a processing task and an input manager of a downstream node, decoupling between data which is processed is realized, and the structure of the processing system is updated without pausing the processing task.

### CROSS-REFERENCE TO RELATED APPLICATIONS

The present disclosure claims priority to Chinese Patent Application No. 202111188642.5, filed with the China National Intellectual Property Administration on Oct. 12, 2021 and entitled “MULTIMEDIA DATA PROCESSING METHOD AND SYSTEM, AND DEVICE”, the disclosure of which is incorporated herein by reference in its entirety.

### FIELD

Embodiments of the present disclosure relate to the field of computer processing technologies, and in particular, to a processing method and system for multimedia data, an electronic device, a computer-readable storage medium, a computer program product, and a computer program.

### BACKGROUND

With the rapid development of electronic devices, the electronic devices have increasingly powerful functions and can process multimedia data. Specifically, the multimedia data can be processed through one processing system. The processing system can include a plurality of processing nodes arranged in a sequential order, so as to process the multimedia data in the order. The processing can include adjusting playing speeds, sound tracks, frequencies, and the like of the multimedia data.

How to update the processing system described above while the processing system described above processes data is a problem needing to be solved urgently.

### SUMMARY

Embodiments of the present disclosure provide a processing method and system for multimedia data, an electronic device, a computer-readable storage medium, a computer program product, and a computer program, so that the processing system described above can be updated while the processing system described above processes data.

According to a first aspect, the embodiments of the present disclosure provide a processing method for multimedia data, applied to a processing system for the multimedia data, the processing system including at least two processing nodes arranged in a sequential order; each processing node corresponding to an input manager and an output manager; two adjacent processing nodes being respectively an upstream node and a downstream node; the output manager of the upstream node and the input manager of the downstream node having an association relationship; the upstream node generating multimedia data for the downstream node; and the method includes:
generating a first processing task when first multimedia data exists in a first input manager of a first processing node, the first processing task including the first multimedia data;
calling the first processing node to execute the first processing task to obtain second multimedia data, the second multimedia data being data obtained by processing the first multimedia data in the first processing task; and
writing the second multimedia data into a second input manager of at least one second processing node, the second input manager being an input manager associated with a first output manager of the first processing node.

According to a second aspect, the embodiments of the present disclosure provide a processing apparatus for multimedia data, applied to a processing system for the multimedia data, the processing system including at least two processing nodes arranged in a sequential order; each processing node corresponding to an input manager and an output manager; two adjacent processing nodes being respectively an upstream node and a downstream node; the output manager of the upstream node and the input manager of the downstream node having an association relationship; the upstream node generating multimedia data for the downstream node; and the apparatus includes:
a first processing task generation module for generating a first processing task when first multimedia data exists in a first input manager of a first processing node, the first processing task including the first multimedia data;
a first processing task execution module for calling the first processing node to execute the first processing task to obtain second multimedia data, the second multimedia data being data obtained by processing the first multimedia data in the first processing task; and a second data writing module for writing the second multimedia data into a second

input manager of at least one second processing node, the second input manager being an input manager associated with a first output manager of the first processing node.

According to a third aspect, the embodiments of the present disclosure provide an electronic device, including: at least one processor and a memory, wherein the memory stores computer-executable instructions; and
the at least one processor executes the computer-executable instructions stored in the memory to cause the electronic device to implement the method as mentioned in the first aspect.

According to a fourth aspect, the embodiments of the present disclosure provide a computer-readable storage medium, wherein the computer-readable storage medium stores computer-executable instructions; and when a processor executes the computer-executable instructions, a computing device is caused to implement the method as mentioned in the first aspect.

According to a fifth aspect, the embodiments of the present disclosure provide a computer program product, including a computer program, and the computer program, when executed by a processor, implements the content as mentioned in the first aspect.

According to a sixth aspect, the embodiments of the present disclosure provide a computer program. The computer program is configured to implement the method as mentioned in the first aspect.

The embodiments of the present disclosure provide a processing method and system for multimedia data, an electronic device, a computer-readable storage medium, a computer program product, and a computer program. The method includes: generating a first processing task when first multimedia data exists in a first input manager of a first processing node, the first processing task including the first multimedia data; calling the first processing node to execute the first processing task to obtain second multimedia data, the second multimedia data being data obtained by processing the first multimedia data in the first processing task; and writing the second multimedia data into a second input manager of at least one second processing node, the second input manager being an input manager associated with a first output manager of the first processing node. According to the method, a processing task and an input manager of a downstream node achieve decoupling between data being processed and data to be processed, and a structure of the processing system is updated without pausing the processing task.

### BRIEF DESCRIPTION OF THE DRAWINGS

To describe the technical solutions in the embodiments of the present disclosure or in the existing technology more clearly, the following briefly introduces the accompanying drawings for describing the embodiments or the existing technology. Apparently, the accompanying drawings in the following description show merely some embodiments of the present disclosure, and a person of ordinary skill in the art may still derive other drawings from the accompanying drawings without creative efforts.

FIG. 1 is a schematic structural diagram of a processing system for multimedia data according to the existing technology;

FIG. 2 is a schematic structural diagram of a processing system after processing nodes are added to the processing system shown in FIG. 1 according to the embodiments of the present disclosure;

FIG. 3 is a schematic structural diagram of a processing system after processing nodes are deleted from the processing system shown in FIG. 2 according to the embodiments of the present disclosure;

FIG. 4 is a schematic structural diagram of a processing system for multimedia data according to the embodiments of the present disclosure;

FIG. 5 is a flowchart of steps of a processing method for multimedia data according to the embodiments of the present disclosure;

FIG. 6 is a schematic structural diagram of a processing task according to the embodiments of the present disclosure;

FIG. 7 is a schematic diagram of a process of scheduling a processing task according to an embodiment of the present disclosure;

FIG. 8 is a schematic structural diagram of a processing system after a fourth processing node is added according to the embodiments of the present disclosure;

FIG. 9 is a structural block diagram of a processing apparatus for multimedia data according to the embodiments of the present disclosure; and

FIG. 10 and FIG. 11 are structural block diagrams of two types of electronic devices according to the embodiments of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure are clearly described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

The embodiments of the present disclosure can be applied to a processing system for multimedia data. The processing system for the data can include a plurality of processing nodes arranged in a sequential order, and a quantity of processing nodes can be set according to an actual application scenario. Each processing node is configured to process the multimedia data, and different processing nodes can have the same or different processing logic. Two adjacent processing nodes can be referred to as an upstream node and a downstream node. Multimedia data output by the upstream node is multimedia data input by the downstream node, which means that after the upstream node processes the multimedia data, the multimedia data is processed by the downstream node.

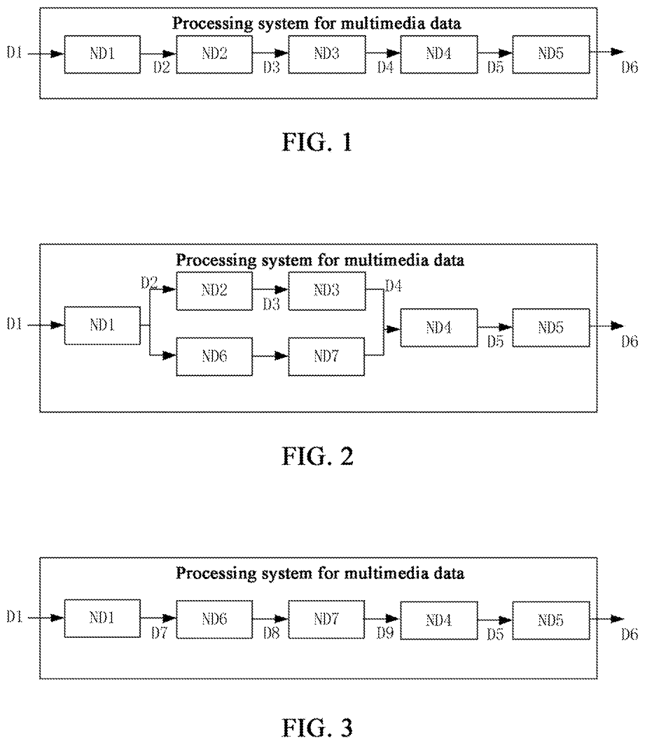

FIG. 1 is a schematic structural diagram of a processing system for multimedia data according to the existing technology. As shown in FIG. 1, the processing system includes five processing nodes arranged in a sequential order: ND1 to ND5. ND1 refers to an upstream node of ND2, ND2 is a downstream node of ND1, and so on. Thus, ND1 processes multimedia data D1 input to the processing system to obtain multimedia data D2; the multimedia data D2 output by ND1 is input to ND2 for processing to obtain multimedia data D3; the multimedia data D3 output by ND2 is input to ND3 for processing to obtain multimedia data D4; the multimedia data D4 output by ND3 is input to ND4 for processing to obtain multimedia data D5; and the multimedia data D5 output by ND4 is input to ND5 for multimedia processing to obtain data D6. In this way, it is equivalent to obtaining D6 after D1 is processed by the processing system.

Each processing node described above can be a multimedia processor provided by an open source multimedia processing framework, where the open source multimedia processing framework can be, for example, Ffmeg and Gstreamer. When the open source multimedia processing framework is Ffmpeg, the multimedia processor can be the avfilter provided by Ffmpeg.

Functions of the processing nodes described above can be different. When ND1 described above is configured to pull a video stream; ND2 is configured to decode a video; ND3 is configured to sharpen an image; ND4 is configured for confluence layout; and ND5 is configured for decoding.

The structure of the processing system described above can be changed, including adding nodes to the processing system and deleting nodes from the processing system.

FIG. 2 is a schematic structural diagram of a processing system after processing nodes are added to the processing system shown in FIG. 1 according to the embodiments of the present disclosure. As shown in FIG. 2, the added processing nodes include ND6 and ND7. An upstream node of ND6 is ND1, a downstream node of ND6 is ND7, and a downstream node of ND7 is ND4. In this way, ND6 and ND7 form a new processing line. Functions of the newly added ND6 and ND7 can be different from the functions of the respective processing nodes in FIG. 1, or can be the same as the functions of some of the nodes in FIG. 1. For example, ND6 is configured for decoding, and ND7 is configured for image segmentation.

FIG. 3 is a schematic structural diagram of a processing system after processing nodes are deleted from the processing system shown in FIG. 2 according to the embodiments of the present disclosure. As shown in FIG. 2 and FIG. 3, the deleted processing nodes include ND2 and ND3.

In the existing technology, two adjacent processing nodes share a data queue. That is, while an upstream node writes data to the data queue, a downstream node acquires data from the data queue. In this case, data to be processed and data being processed of the downstream node are indistinguishable and are both in the data queue. Therefore, in order to ensure that no error is reported in a processing process of the downstream processing node, it is necessary to pause the processing process of each processing node in the processing system described above before the update of the structure of the processing system. The processing process of each processing node in the processing system is continued after the update of the structure of the processing system.

It can be seen that the processing system needs to be paused in the above scheme, which reduces the processing efficiency of the processing system.

In order to solve the aforementioned technical problems, the embodiments of the present disclosure can update the structure of the processing system without pausing the processing system. Considering that the reason for pausing the processing system is that the data to be processed and the data being processed of the downstream node are indistinguishable, the embodiments of the present disclosure can achieve decoupling between the data being processed and the data to be processed by a processing task and an input manager of the downstream node. The processing task includes the data being processed of the downstream node, and the input manager of the downstream node includes the data to be processed of the downstream node. In this way, updating the structure of the processing system will not affect the execution of the processing task, thus achieving the update of the structure of the processing system without pausing the processing task and improving the processing efficiency of the processing system.

The technical solutions of the embodiments of the present disclosure and how to solve the aforementioned technical problems by the technical solutions of the present disclosure will be described in detail below by specific embodiments. The following specific embodiments can be combined with each other, and the same or similar concepts or processes may not be repeated in some embodiments. The following will describe the embodiments of the present disclosure in conjunction with the accompanying drawings.

Similar to the processing system shown in FIG. 1, a processing system provided in the embodiments of the present disclosure also includes at least two processing nodes arranged in a sequential order. However, a difference lies in that each processing node in the embodiments of the present disclosure corresponds to an input manager and an output manager. Two adjacent processing nodes are respectively an upstream node and a downstream node; the output manager of the upstream node and the input manager of the downstream node have an association relationship; and the upstream node generates multimedia data for the downstream node.

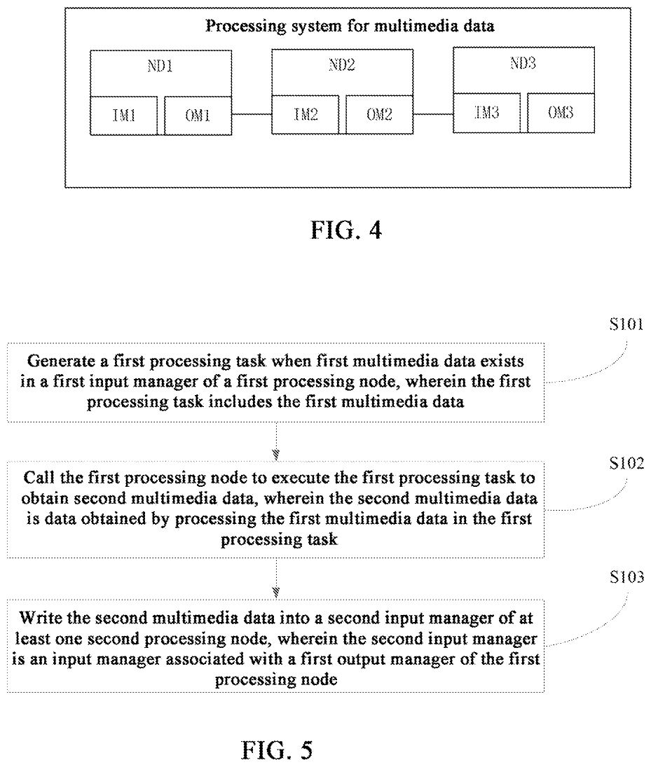

FIG. 4 is a schematic structural diagram of a processing system for multimedia data according to the embodiments of the present disclosure. As shown in FIG. 4, the processing system includes three processing nodes arranged in a sequential order: ND1 to ND3.

ND1 and ND2 are two adjacent processing nodes. ND1 is an upstream node of ND2, and ND2 is a downstream node of ND1. An output manager OM1 of ND1 and an input manager IM2 of ND2 have an association relationship.

ND2 and ND3 are two adjacent processing nodes. ND2 is an upstream node of ND3, and ND3 is a downstream node of ND2. An output manager OM2 of ND2 and an input manager IM3 of ND3 have an association relationship.

It can be seen that an input manager IM1 of the first processing node ND1 does not have an associated output manager. The first processing node can usually be a node that receives data, and the first processing node can be started according to a time cycle, for example, every 1 minute.

In addition, an output manager OM3 of the last processing node ND3 does not have an associated input manager. The last processing node usually does not output data, and is usually configured to store data.

The input manager described above is configured to store input data of the processing node, while the output manager is configured to indicate which input manager the output data of the processing node is input to, that is, specify a downstream node of the processing node.

FIG. 5 is a flowchart of steps of a processing method for multimedia data according to the embodiments of the present disclosure. The method shown in FIG. 5 can be applied to an electronic device. The electronic device can be understood as a scheduler, a controller, or an engine of the above processing system. As shown in FIG. 5, the processing method for the multimedia data includes:
S101: A first processing task is generated when first multimedia data exists in a first input manager of a first processing node, the first processing task includes the first multimedia data,
wherein the first processing node is any processing node in the processing system shown in FIG. 4 above. The first input manager is an input manager of the first processing node. The first multimedia data is multimedia data to be processed of the first processing node. The first processing task is a processing task of the first processing node. One processing node can correspond to one or more processing tasks.

A processing task can be understood as a structure that stores task information, which can include at least one piece of following information: identifier information of a processing node, multimedia data input to an input manager of the processing node, multimedia data output to an output manager of the processing node, and generation time of the processing task.

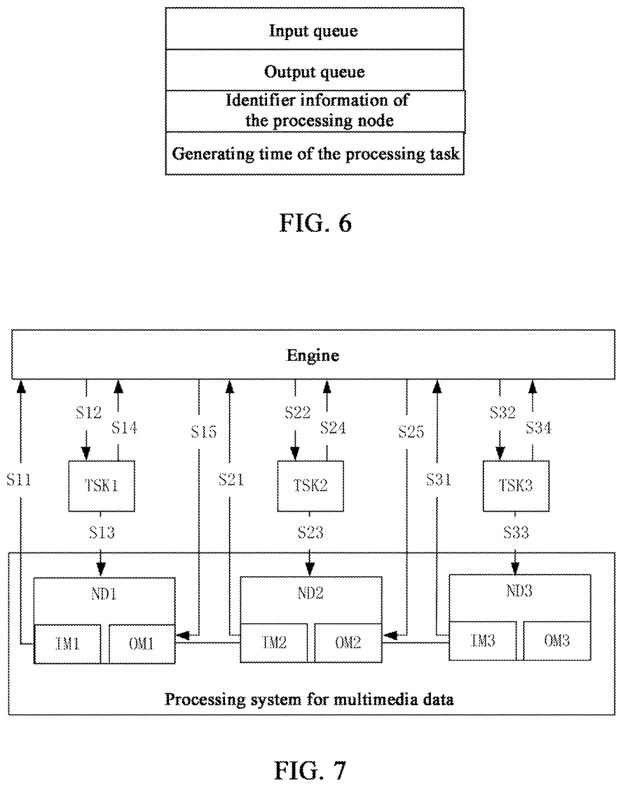

FIG. 6 is a schematic structural diagram of a processing task according to the embodiments of the present disclosure. As shown in FIG. 6, an input queue stores multimedia data input to an input manager of a processing node, and an output queue stores multimedia data output to an output manager of a processing node.

It should be noted that after a processing task is generated, the multimedia data in the input queue can be understood as multimedia data being processed of the processing node, while the output queue is empty. After the execution of the processing task is completed, the multimedia data is stored in the output queue.

S102: The first processing node is called to execute the first processing task to obtain second multimedia data, the second multimedia data is data obtained by processing the first multimedia data in the first processing task,
wherein when the execution of the first processing task is completed, the second multimedia data is stored in an output queue of the first processing task.

S103: The second multimedia data is written into a second input manager of at least one second processing node, the second input manager is an input manager associated with a first output manager of the first processing node,
wherein the second processing node is a downstream node of the first processing node. It can be understood that one first processing node can correspond to one or more downstream nodes.

When the execution of the first processing task is completed, the second multimedia data can be extracted from the output queue of the first processing task and written into the second input manager.

Based on the processes of S101 to S103 mentioned above, FIG. 7 is a schematic diagram of a process of scheduling a processing task according to an embodiment of the present disclosure.

As shown in FIG. 7, for the first processing node ND1, scheduling can include the following steps:
S11: An engine extracts multimedia data D11 from the input manager IM1 of the processing node ND1.
S12: The engine generates a processing task TSK1 of ND1 based on D11, wherein TSK1 includes D11, an empty output queue, identifier information of ND1, and a timestamp t1.
S13: The engine calls ND1 to execute TSK1 according to the identifier information of ND1 in TSK1, and obtained multimedia data D12 is stored in an output queue of TSK1.
S14: After the execution of TSK1 is completed, the engine extracts D12 from the output queue of TSK1.
S15: The engine first determines the output manager OM1 of ND1 according to the identifier information of ND1 in TSK1, then determines the input manager IM2 associated with OM1, and writes D12 into IM2.

As shown in FIG. 7, for the second processing node ND2, scheduling can include the following steps:

S21: An engine extracts multimedia data D21 from the input manager IM2 of the processing node ND2.

S22: The engine generates a processing task TSK2 of ND2 based on D21, wherein TSK2 includes D21, an empty output queue, identifier information of ND2, and a timestamp t2.

S23: The engine calls ND2 to execute TSK2 according to the identifier information of ND2 in TSK2, and obtained multimedia data D22 is stored in an output queue of TSK2.

S24: After the execution of TSK2 is completed, the engine extracts D22 from the output queue of TSK2.

S25: The engine first determines the output manager OM2 of ND2 according to the identifier information of ND2 in TSK2, then determines the input manager IM3 associated with OM2, and writes D22 into IM3.

As shown in FIG. 7, for the second processing node ND3, scheduling can include the following steps:

S31: An engine extracts multimedia data D31 from the input manager IM3 of the processing node ND3.

S32: The engine generates a processing task TSK3 of ND3 according to D31, TSK3 includes D31, an empty output queue, identifier information of ND3, and a timestamp t3.

S33: The engine calls ND3 to execute TSK3 according to the identifier information of ND3 in TSK3.

S34: The engine determines that no data exists in the output queue of TSK3, indicating that ND3 is the last processing node.

It should be noted that the above process only shows one processing task for one processing node. In practical applications, one processing node can include a plurality of processing tasks. The identifier information of the processing nodes in different processing tasks of one processing node is the same, but following contents are different: the multimedia data in the input queues, the multimedia data in the output queues, and timestamps.

Based on the processing system described above, the embodiments of the present disclosure can update the structure of the processing system without pausing the processing system. The update of the structure of the processing system can include deleting a third processing node and adding a fourth processing node. The third processing node is any processing node to be deleted in the processing system. The fourth processing node is any processing node to be added.

A process of deleting a third processing node from the processing system will be described in detail below.

In the embodiments of the present disclosure, the process of deleting a third processing node may include: firstly, determining a third processing node to be deleted in the processing system and a first adjacent node of the third processing node, wherein the first adjacent processing node can include at least one of: a first upstream node and/or a first downstream node; and then, deleting an association relationship between the input manager of the third processing node and the output manager of the first upstream node; and/or, deleting the association relationship between the output manager of the third processing node and the input manager of the first downstream node.

When the third processing node is the first processing node in the processing system, the third processing node has a first downstream node, but does not have a first upstream node. In this way, only the association relationship between the output manager of the third processing node and the input manager of the first downstream node needs to be deleted.

When the third processing node is the last processing node in the processing system, the third processing node has a first upstream node, but does not have a first downstream node. In this way, only the association relationship between the input manager of the third processing node and the output manager of the first upstream node needs to be deleted.

The first upstream node is an upstream node of the third processing node, and the first downstream node is a downstream node of the third processing node.

It can be understood that the nodes in the processing system are interrelated. If one node is not associated with other nodes, it means that the processing node has been deleted from the processing system. Thus, the embodiments of the present disclosure can achieve the purpose of deleting the third processing node by deleting the association relationship between the input manager of the third processing node and the output manager of the first upstream node, as well as deleting the association relationship between the output manager of the third processing node and the input manager of the first downstream node.

It can be understood that when a position of the third processing node in the processing system is different, the structure of the processing system is different after the third processing node is deleted.

When the third processing node is the first or last processing node, after the third processing node is deleted, the association relationships between the respective remaining processing nodes in the processing system are not broken, and the association relationships described above still constitute a complete processing system. In this way, the processing system does not need to be repaired.

When the third processing node is an intermediate processing node, after the third processing node is deleted, the first upstream node and the first downstream node are disconnected. In this way, whether to repair the processing system needs to be determined according to whether the first upstream node has a downstream node, and/or whether the first downstream node has an upstream node.

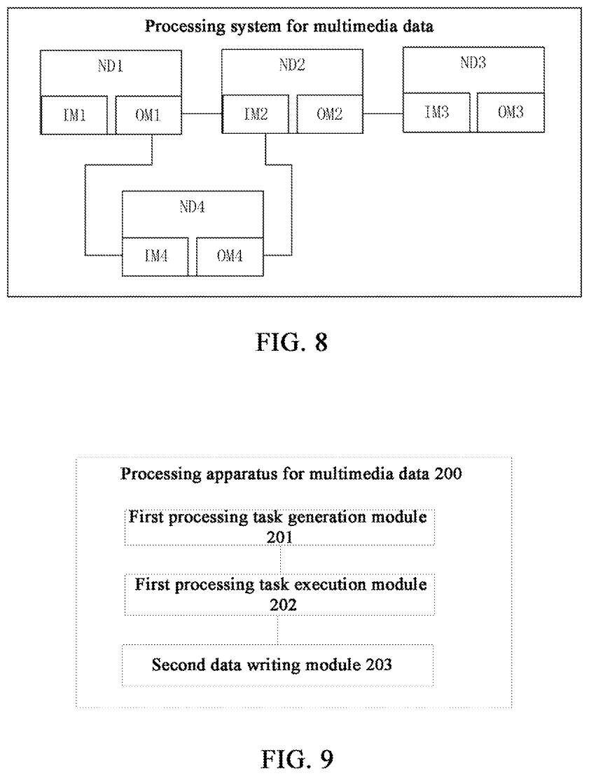

When the first upstream node has a downstream node, and the first downstream node has an upstream node, the processing system is not repaired. As shown in FIG. 8, when ND4 is a third processing node, after ND4 is deleted, the first upstream node ND1 has a downstream node ND2, and the first downstream node ND2 has an upstream node ND1. In this way, the processing system may not be repaired.

When the first upstream node does not have a downstream node, and/or when the first downstream node does not have an upstream node, the processing system is repaired, namely, by establishing an association between the output manager of the first upstream node and the input manager of the first downstream node. In this way, it can ensure that a link of the entire processing system is connected. As shown in FIG. 8, when ND2 is a third processing node, after ND2 is deleted, the first upstream nodes ND1 and ND4 do not have a downstream node, and the first downstream node ND3 does not have an upstream node. In this way, the association relationship between the output manager OM1 of the first upstream node ND1 and the input manager IM3 of the first downstream node ND3 can be established, and the association relationship between the first upstream node ND4 and the input manager IM3 of the first downstream node ND3 can be established.

Of course, after the two association relationships described are deleted, the third processing node can also be released to save computer resources occupied by the third processing node.

Before the association relationship between the input manager of the third processing node and the output manager of the first upstream node is deleted, a first label can be set in the output manager of the first upstream node, wherein the first label is used for indicating that a processing task of the first upstream node stops generating multimedia data for the input manager of the third processing node.

Specifically, when the input manager of the first upstream node is associated with the input managers of at least two downstream nodes, the first label is set for the input manager of the third processing node only, and no first label is set for the input managers of the remaining downstream nodes. In this way, only the processing task of generating data for the third processing node is stopped, and the processing task of generating data for other downstream nodes is not stopped. This can prevent the first upstream node from continuing to generate data for the third processing node. After the generated data stored in the input manager of the third processing node has been completely processed by the third processing node, the association relationship between the output manager of the first upstream node and the input manager of the third processing node can be deleted.

Optionally, before the association relationship between the input manager of the third processing node and the output manager of the first upstream node is deleted, whether a first preset condition is satisfied needs to be determined. If the first preset condition is satisfied, the association relationship between the input manager of the third processing node and the output manager of the first upstream node is deleted. If the first preset condition is not satisfied, the association relationship between the input manager of the third processing node and the output manager of the first upstream node is not deleted.

The first preset condition described above can include at least one: no target processing task exists, and no fourth multimedia data exists in the input manager of the third processing node. The target processing task is a processing task being executed by the first upstream node, and the target processing task is used for generating multimedia data for the input manager of the third processing node.

The fourth multimedia data described above is the multimedia data in the input manager of the third processing node, that is, the multimedia data to be processed of the third processing node.

When the third processing node is ND2 in the processing system shown in FIG. 4, the first upstream node is ND1, and the first downstream node is ND3. The target processing task is a processing task that is currently being executed by ND1 and generates multimedia data for ND2. The input manager of the third processing node is IM2.

It can be understood that no fourth multimedia data exists in the input manager of the third processing node, which indicates that no multimedia data to be processed exists in the third processing node. The absence of a target processing task means that there is no processing task that is generating multimedia data to be processed for the third processing node. In this case, deleting the association relationship between the input manager of the third processing node and the output manager of the first upstream node avoids the fourth multimedia data from being discarded and/or avoids multimedia data output by a target processing task from being discarded. Thus, some fragments of multimedia data are avoided from being missed during playing, which can contribute to improving the smoothness of playing of multimedia data.

Of course, if fourth multimedia data exists in the input manager of the third processing node, firstly, a second processing task is generated, wherein the second processing task includes the fourth multimedia data; and then, the association relationship between the input manager of the third processing node and the output manager of the first upstream node is deleted.

It can be understood that when the second processing task is generated, the fourth multimedia data is loaded into the second processing task, and the input manager of the third processing node no longer stores the fourth multimedia data. In this way, the association relationship between the input manager of the third processing node and the output manager of the first upstream node can be deleted.

It should be noted that if all the first preset conditions described above are satisfied, the smoothness of playing of multimedia data can be ensured to the maximum extent.

After the second processing task is generated, the engine can call the third processing node to execute the second processing task, and after the execution of the second processing task is completed, computer resources occupied by the third processing node are released.

Correspondingly, before the association relationship between the output manager of the third processing node and the input manager of the first downstream node is deleted, whether a second preset condition is satisfied also needs to be determined. If the second preset condition is satisfied, the association relationship between the output manager of the third processing node and the input manager of the first downstream node is deleted. If the second preset condition is not satisfied, the association relationship between the output manager of the third processing node and the input manager of the first downstream node is not deleted.

The second preset condition described above can include: no multimedia data exists in the input manager of the third processing node, and/or no processing task being operated by the third processing node exists. It represents that the third processing node will not generate multimedia data for a second downstream node, thus preventing the following phenomenon: There is no input manager for inputting the obtained multimedia data after the multimedia data in the input manager of the third processing node is completely processed or the execution of the processing task that is being operated is completed, causing the processed data to be discarded. Thus, some fragments of multimedia data are avoided from being missed during playing, which can contribute to improving the smoothness of playing of multimedia data.

A process of adding a fourth processing node into the processing system will be described in detail below.

In the embodiments of the present disclosure, the process of adding a fourth processing node may include: firstly, determining a fourth processing node to be added and a second adjacent node of the fourth processing node, wherein the second adjacent node includes a second upstream node and/or a second downstream node, and the second upstream node and the second downstream node are existing processing nodes in the processing system; and then, establishing an association relationship between the output manager of the second upstream node and the input manager of the fourth processing node; and/or, establishing an association relationship between the output manager of the fourth processing node and the input manager of the second downstream node.

The fourth processing node is a processing node to be added with any function, and the fourth processing node is added between the second upstream node and the second downstream node in the existing processing system. The second upstream node and the second downstream node can be two adjacent processing nodes or two non-adjacent processing nodes.

Based on the processing system shown in FIG. 4, FIG. 8 is a schematic structural diagram of a processing system after a fourth processing node is added according to the embodiments of the present disclosure. As shown in FIG. 8, ND4 is a fourth processing node. A second upstream node of ND4 is ND1, and a second downstream node of ND4 is ND2. Thus, when ND4 is added, the association relationship between the output manager OM1 of the second upstream node ND1 and the input manager IM4 of the fourth processing node ND4 is established first, and the association relationship between the output manager OM4 of the fourth processing node ND4 and the input manager IM2 of the second downstream node ND2 is then established. In this way, the purpose of adding the fourth processing node ND4 between ND1 and ND2 in the processing system shown in FIG. 4 is achieved, thus obtaining the processing system shown in FIG. 8.

Of course, in practical applications, the fourth processing node may not have a second upstream node or a second downstream node.

When the fourth processing node is added in front of the first processing node ND1 shown in FIG. 4, the fourth processing node does not have a second upstream node, but has a second downstream node ND1. After being added, the fourth processing node is the new first processing node of the processing system.

When the fourth processing node is added behind the last processing node ND3 shown in FIG. 4, the fourth processing node does not have a second downstream node, but has a second upstream node ND3. After being added, the fourth processing node is the new last processing node of the processing system.

It can be seen that when the fourth processing node is added, all the existing processing nodes in the processing system do not need to stop running, that is, their processing tasks can continue to be executed.

Corresponding to the processing method for the multimedia data in the previous embodiments, FIG. 9 is a structural block diagram of a processing apparatus for multimedia data according to the embodiments of the present disclosure, which is applied to the aforementioned processing system for the multimedia data. For ease of explanation, only parts related to the embodiments of the present disclosure are shown. Referring to FIG. 9, the processing apparatus 200 for the multimedia data described above includes: a first processing task generation module 201, a first processing task execution module 202, and a second data writing module 203.

The first processing task generation module 201 is for generating a first processing task when first multimedia data exists in a first input manager of a first processing node, the first processing task including the first multimedia data.

The first processing task execution module 202 is for calling the first processing node to execute the first processing task to obtain second multimedia data, the second multimedia data is data obtained by processing the first multimedia data in the first processing task.

The second data writing module 203 is for writing the second multimedia data into a second input manager of at least one second processing node, the second input manager is an input manager associated with a first output manager of the first processing node.

Optionally, the apparatus further includes:
a third node determining module for determining a third processing node to be deleted in the processing system and a first adjacent node of the third processing node, the first adjacent node includes a first upstream node and/or a first downstream node; and
a relationship deletion module for deleting an association relationship between an input manager of the third processing node and an output manager of the first upstream node; and/or, deleting an association relationship between an output manager of the third processing node and an input manager of the first downstream node.

Optionally, the apparatus further includes:
a labeling module for setting a first label in the output manager of the first upstream node before the association relationship between the input manager of the third processing node and the output manager of the first upstream node is deleted, the first label is used for indicating that a processing task of the first upstream node stops generating multimedia data for the input manager of the third processing node.

Optionally, the relationship deletion module is further for:
deleting the association relationship between the input manager of the third processing node and the output manager of the first upstream node when no target processing task exists, the target processing task is a processing task being executed by the first upstream node, and the target processing task is used for generating multimedia data for the input manager of the third processing node.

Optionally, the relationship deletion module is further for:
deleting the association relationship between the input manager of the third processing node and the output manager of the first upstream node when it is detected that no fourth multimedia data exists in the input manager of the third processing node.

Optionally, the relationship deletion module is further for:
generating a second processing task when it is detected that fourth multimedia data exists in the input manager of the third processing node, the second processing task including the fourth multimedia data; and deleting the association relationship between the input manager of the third processing node and the output manager of the first upstream node.

Optionally, the relationship deletion module is further for:
deleting the association relationship between the output manager of the third processing node and the input manager of the first downstream node when no multimedia data exists in the input manager of the third processing node, and/or when no processing task being executed by the third processing node exists.

Optionally, when the third processing node has the first upstream node and the first downstream node, the apparatus further includes:
a relationship repair module for establishing an association relationship between the output manager of the first upstream node and the input manager of the first downstream node if the first upstream node does not have a downstream node, and/or if the first downstream node does not have an upstream node after the two types of association relationships are deleted.

Optionally, the apparatus further includes:
a fourth node determining module for determining a fourth processing node to be added and a second adjacent node of the fourth processing node, the second adjacent node including a second upstream node and/or a second downstream node, and the second upstream node and the second downstream node being existing processing nodes in the processing system; and
a relationship establishment module for establishing an association relationship between an output manager of the second upstream node and an input manager of the fourth processing node; and/or, establishing an association relationship between an output manager of the fourth processing node and an input manager of the second downstream node.

Optionally, the processing task of each processing node includes at least one piece of following information: identifier information of the processing node, multimedia data input to the input manager of the processing node, multimedia data output to the output manager of the processing node, and generation time of the processing task.

The processing apparatus for the multimedia data according to this embodiment can be configured to implement the technical solution of the method embodiment shown in FIG. 5 described above, and an implementation principle and technical effects thereof are similar to those of the method embodiment, so that the processing apparatus will not be described in detail here in this embodiment.

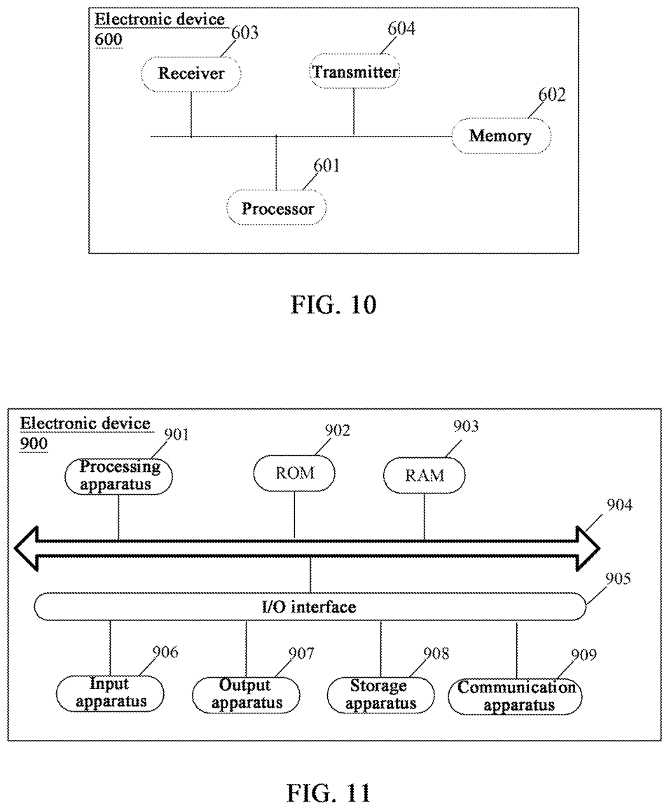

FIG. 10 is a structural block diagram of an electronic device 600 according to the embodiments of the present disclosure. The electronic device 600 includes a memory 602 and at least one processor 601,
wherein the memory 602 stores computer-executable instructions; and
the at least one processor 601 executes the computer-executable instructions stored in the memory 602 to cause the electronic device 601 to implement the aforementioned method in FIG. 5.

In addition, the electronic device may further include a receiver 603 and a transmitter 604. The receiver 603 is configured to receive information from other apparatuses or devices and forward the information to the processor 601, and the transmitter 604 is configured to transmit information to other apparatuses or devices.

Further, referring to FIG. 11, a schematic structural diagram of an electronic device 900 suitable for implementing the embodiments of the present disclosure is shown. The electronic device 900 can be a terminal device. The terminal device can include but is not limited to mobile terminals such as a mobile phone, a laptop, a digital broadcast receiver, a Personal Digital Assistant (PDA), a Portable Android Device (PAD), a Portable Media Player (PMP), a vehicle-mounted terminal (such as a vehicle-mounted navigation terminal), and fixed terminals such as a digital TV and a desk computer. The electronic device shown in FIG. 11 is only an example and should not impose any limitations on the functionality and scope of use of the embodiments of the present disclosure.

As shown in FIG. 11, the electronic device 900 may include a processing apparatus (such as a central processing unit and graphics processor) 901 that can perform various appropriate actions and processing according to programs stored in a Read Only Memory (ROM) 902 or loaded from a storage apparatus 908 to a Random Access Memory (RAM) 903. Various programs and data required for operations of the electronic device 900 may also be stored in the RAM 903. The processing apparatus 901, the ROM 902, and the RAM 903 are connected to each other through a bus 904. An Input/Output (I/O) interface 905 is also connected to a bus 904.

Usually, following apparatuses can be connected to the I/O interface 905: an input apparatus 906 including a touch screen, a touchpad, a keyboard, a mouse, a camera, a microphone, an accelerometer, a gyroscope, and the like; an output apparatus 907 including a Liquid Crystal Display (LCD), a speaker, a vibrator, and the like; a storage apparatus 908 including a magnetic tape, a hard disk drive, and the like; and a communication apparatus 909. The communication apparatus 909 can allow the electronic device 900 to wirelessly or wiredly communicate with other devices to exchange data. Although FIG. 11 shows the electronic device 900 with multiple apparatuses, it should be understood that the electronic device 900 is not required to implement or have all the apparatuses shown, and can alternatively implement or have more or fewer apparatuses.

Particularly, according to the embodiments of the present disclosure, the process described in the reference flowchart above can be implemented as a computer software program. For example, the embodiments of the present disclosure include a computer program product, including a computer program carried on a computer-readable medium, and the computer program includes program codes used for performing the methods shown in the flowcharts. In such an embodiment, the computer program may be downloaded and installed from a network through the communication apparatus 909, or installed from the storage apparatus 908, or installed from the ROM 902. When the computer program is executed by the processing apparatus 901, the above-mentioned functions defined in the methods of the embodiments of the present disclosure are executed.

It should be noted that the computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage media may include, but are not limited to: an electrical connection with one or more wires, a portable computer disk, a hard disk drive, a RAM), a ROM, an Erasable Programmable Read Only Memory (EPROM or flash memory), an optical fiber, Compact Disk Read Only Memory (CD-ROM), an optical storage device, a magnetic storage device, or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signals can be in various forms, including but not limited to: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but not limited to: a wire, an optical cable, a Radio Frequency (RF), and the like, or any suitable combination of the above.

The computer-readable medium may be included in the electronic device or exist alone and is not assembled into the electronic device.

The above computer-readable medium carries one or more programs. When executed by the electronic device, the one or more programs cause the electronic device to implement the methods shown in the above embodiments.

Computer program codes for performing the operations of the present disclosure may be written in one or more programming languages or a combination thereof. The above programming languages include an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case that a remote computer is involved, the remote computer can be connected to a user computer through any kind of networks, including a LAN or a WAN, or can be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present disclosure can be implemented through software or hardware. The name of the unit does not constitute a limitation on the unit itself. For example, the first obtaining unit can also be described as “a unit that obtains at least two Internet protocol addresses”.

The functions described herein above may be performed, at least in part, by one or a plurality of hardware logic components. For example, nonrestrictively, exemplary hardware logic components that can be used include: a Field Programmable Gate Array (FPGA), an Application Specific Integrated Circuit (ASIC), an Application Specific Standard Product (ASSP), a System On Chip (SOC), a Complex Programmable Logic Device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

In a first example of a first aspect, the embodiments of the present disclosure provide a processing method for multimedia data, applied to a processing system for the multimedia data, the processing system including at least two processing nodes arranged in a sequential order; each processing node corresponding to an input manager and an output manager; two adjacent processing nodes being respectively an upstream node and a downstream node; the output manager of the upstream node and the input manager of the downstream node having an association relationship; the upstream node generating multimedia data for the downstream node; and the method includes:
generating a first processing task when first multimedia data exists in a first input manager of a first processing node, the first processing task including the first multimedia data;
calling the first processing node to execute the first processing task to obtain second multimedia data, the second multimedia data being data obtained by processing the first multimedia data in the first processing task; and
writing the second multimedia data into a second input manager of at least one second processing node, the second input manager being an input manager associated with a first output manager of the first processing node.

Based on the first example of the first aspect, in a second example of the first aspect, the method further includes: determining a third processing node to be deleted in the processing system and a first adjacent node of the third processing node, the first adjacent node including a first upstream node and/or a first downstream node; and deleting the association relationship between the input manager of the third processing node and the output manager of the first upstream node; and/or, deleting the association relationship between the output manager of the third processing node and the input manager of the first downstream node.

Based on the second example of the first aspect, in a third example of the first aspect, before the deleting the association relationship between the input manager of the third processing node and the output manager of the first upstream node, the method further includes:
setting a first label in the output manager of the first upstream node, the first label being used for indicating that a processing task of the first upstream node stops generating multimedia data for the input manager of the third processing node.

Based on the second example of the first aspect, in a fourth example of the first aspect, the deleting the association relationship between the input manager of the third processing node and the output manager of the first upstream node includes:
deleting the association relationship between the input manager of the third processing node and the output manager of the first upstream node when no target processing task exists, the target processing task being a processing task being executed by the first upstream node, and the target processing task being used for generating multimedia data for the input manager of the third processing node.

Based on the second example of the first aspect, in a fifth example of the first aspect, before the deleting the association relationship between the input manager of the third processing node and the output manager of the first upstream node, the method further includes:
deleting the association relationship between the input manager of the third processing node and the output manager of the first upstream node when it is detected that no fourth multimedia data exists in the input manager of the third processing node.

Based on the second example of the first aspect, in a sixth example of the first aspect, the deleting the association relationship between the input manager of the third processing node and the output manager of the first upstream node includes:
generating a second processing task when it is detected that fourth multimedia data exists in the input manager of the third processing node, the second processing task including the fourth multimedia data; and deleting the association relationship between the input manager of the third processing node and the output manager of the first upstream node.

Based on any one of the second example to the sixth example of the first aspect, in a seventh example of the first aspect, the deleting the association relationship between the output manager of the third processing node and the input manager of the first downstream node, the method further includes:
deleting the association relationship between the output manager of the third processing node and the input manager of the first downstream node when no multimedia data exists in the input manager of the third processing node, and/or when no processing task being executed by the third processing node exists.

Based on any one of the second example to the sixth example of the first aspect, in an eighth example of the first aspect, when the third processing node has the first upstream node and the first downstream node, the method further includes:
after the two types of association relationships are deleted, if the first upstream node does not have a downstream node, and/or if the first downstream node does not have an upstream node, establishing an association relationship between the output manager of the first upstream node and the input manager of the first downstream node.

Based on any one of the second example to the sixth example of the first aspect, in a ninth example of the first aspect, the method further includes:
determining a fourth processing node to be added and a second adjacent node of the fourth processing node, the second adjacent node including a second upstream node and/or a second downstream node, and the second upstream node and the second downstream node being existing processing nodes in the processing system; establishing an association relationship between the output manager of the second upstream node and the input manager of the fourth processing node; and/or, establishing an association relationship between the output manager of the fourth processing node and the input manager of the second downstream node.

Based on any one of the second example to the sixth example of the first aspect, in a tenth example of the first aspect, the processing task of each processing node includes at least one piece of following information: identifier information of the processing node, multimedia data input to the input manager of the processing node, multimedia data output to the output manager of the processing node, and generation time of the processing task.

In a first example of a second aspect, a processing apparatus for multimedia data is provided, applied to a processing system for the multimedia data, wherein the processing system includes at least two processing nodes arranged in a sequential order; each processing node corresponds to an input manager and an output manager; two adjacent processing nodes are an upstream node and a downstream node respectively; the output manager of the upstream node and the input manager of the downstream node have an association relationship; the upstream node generates multimedia data for the downstream node; and the apparatus includes:
a first processing task generation module for generating a first processing task when first multimedia data exists in a first input manager of a first processing node, the first processing task including the first multimedia data;
a first processing task execution module for calling the first processing node to execute the first processing task to obtain second multimedia data, the second multimedia data being data obtained by processing the first multimedia data in the first processing task; and
a second data writing module for writing the second multimedia data into a second input manager of at least one second processing node, the second input manager being an input manager associated with a first output manager of the first processing node.

Based on the first example of the second aspect, in a second example of the second aspect, the apparatus further includes:
a third node determining module for determining a third processing node to be deleted in the processing system and a first adjacent node of the third processing node, the first adjacent node including a first upstream node and/or a first downstream node; and
a relationship deletion module for deleting an association relationship between an input manager of the third processing node and an output manager of the first upstream node; and/or, deleting an association relationship between an output manager of the third processing node and an input manager of the first downstream node.

Based on the second example of the second aspect, in a third example of the second aspect, the apparatus further includes:
a labeling module for setting a first label in the output manager of the first upstream node before the association relationship between the input manager of the third processing node and the output manager of the first upstream node is deleted, the first label being used for indicating that a processing task of the first upstream node stops generating multimedia data for the input manager of the third processing node.

Based on the second example of the second aspect, in a fourth example of the second aspect, the relationship deletion module is further for:
deleting the association relationship between the input manager of the third processing node and the output manager of the first upstream node when no target processing task exists, the target processing task being a processing task being executed by the first upstream node, and the target processing task being used for generating multimedia data for the input manager of the third processing node.

Based on the second example of the second aspect, in a fifth example of the second aspect, the relationship deletion module is further for:
deleting the association relationship between the input manager of the third processing node and the output manager of the first upstream node when it is detected that no fourth multimedia data exists in the input manager of the third processing node.

Based on the second example of the second aspect, in a sixth example of the second aspect, the relationship deletion module is further for:
generating a second processing task when it is detected that fourth multimedia data exists in the input manager of the third processing node, the second processing task including the fourth multimedia data; and delete the association relationship between the input manager of the third processing node and the output manager of the first upstream node.

Based on any one of the second example to the sixth example of the second aspect, in a seventh example of the second aspect, the relationship deletion module is further for:
deleting the association relationship between the output manager of the third processing node and the input manager of the first downstream node when no multimedia data exists in the input manager of the third processing node, and/or when no processing task being executed by the third processing node exists.

Based on any one of the second example to the sixth example of the second aspect, in an eighth example of the second aspect, when the third processing node has the first upstream node and the first downstream node, the apparatus further includes:
a relationship repair module for establishing an association relationship between the output manager of the first upstream node and the input manager of the first downstream node if the first upstream node does not have a downstream node, and/or if the first downstream node does not have an upstream node after the two types of association relationships are deleted.

Based on any one of the second example to the sixth example of the second aspect, in a ninth example of the second aspect, the apparatus further includes:
a fourth node determining module for determining a fourth processing node to be added and a second adjacent node of the fourth processing node, the second adjacent node including a second upstream node and/or a second downstream node, and the second upstream node and the second downstream node are existing processing nodes in the processing system; and
a relationship establishment module for establishing an association relationship between an output manager of the second upstream node and an input manager of the fourth processing node; and/or, establishing an association relationship between an output manager of the fourth processing node and an input manager of the second downstream node.

Based on any one of the second example to the sixth example of the second aspect, in a tenth example of the second aspect, the processing task of each processing node includes at least one piece of following information: identifier information of the processing node, multimedia data input to the input manager of the processing node, multimedia data output to the output manager of the processing node, and generation time of the processing task.

In a third aspect, according to one or more embodiments of the present disclosure, an electronic device is provided, including: at least one processor and a memory,
wherein the memory stores computer-executable instructions; and
the at least one processor executes the computer-executable instructions stored in the memory to cause the electronic device to implement the method according to any example of the first aspect.

In a fourth aspect, according to one or more embodiments of the present disclosure, a computer-readable storage medium is provided, wherein the computer-readable storage medium stores computer-executable instructions; and when a processor executes the computer-executable instructions, a computing device is caused to implement the method according to any example of the first aspect.

In a fifth aspect, according to one or more embodiments of the present disclosure, a computer program product is provided, including a computer program. The computer program is configured to implement the method according to any example of the first aspect.

In a sixth aspect, according to one or more embodiments of the present disclosure, a computer program is provided. The computer program is configured to implement the method according to any example of the first aspect.

The above description is only for explaining the preferred embodiments of the present disclosure and technical principles used in the embodiments. Those skilled in the art should understand that the scope of disclosure referred to in the present disclosure is not limited to the technical solutions formed by specific combinations of the aforementioned technical features, but also covers other technical solutions formed by any combinations of the aforementioned technical features or their equivalent features without departing from the concept of the above disclosure, For example, a technical solution formed by replacing the above features with (but not limited to) technical features with similar functions disclosed in the present disclosure.

In addition, although various operations are depicted in a specific order, this should not be understood as requiring these operations to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features that are described in the context of the single embodiment may also be implemented in a plurality of embodiments separately or in any suitable sub-combinations.

Although the subject matter has been described in a language specific to structural features and/or method logical actions, it should be understood that the subject matter limited in the attached claims may not necessarily be limited to the specific features or actions described above. On the contrary, the specific features and actions described above are only exemplary forms for implementing the claims.

What is claimed is:

1. A processing method for multimedia data, applied to a processing system for the multimedia data, wherein the processing system comprises at least two processing nodes arranged in a sequential order; each processing node corresponding to an input manager and an output manager; two adjacent processing nodes being an upstream node and a downstream node respectively; an output manager of the upstream node and an input manager of the downstream node having an association relationship; the upstream node generating multimedia data for the downstream node; and the method comprises:
generating a first processing task when first multimedia data exists in a first input manager of a first processing node, wherein the first processing task comprises the first multimedia data;
calling the first processing node to execute the first processing task to obtain second multimedia data, the second multimedia data being data obtained by processing the first multimedia data in the first processing task; and
writing the second multimedia data into a second input manager of at least one second processing node, the second input manager being an input manager associated with a first output manager of the first processing node.

2. The method according to claim 1, wherein the method further comprises:
determining a third processing node to be deleted in the processing system and a first adjacent node to the third processing node, wherein the first adjacent node comprises a first upstream node and/or a first downstream node; and
deleting an association relationship between an input manager of the third processing node and an output manager of the first upstream node; and/or, deleting an association relationship between an output manager of the third processing node and an input manager of the first downstream node.

3. The method according to claim 2, wherein before deleting the association relationship between the input manager of the third processing node and the output manager of the first upstream node, the method further comprises:
setting a first label in the output manager of the first upstream node, the first label being used for indicating that a processing task of the first upstream node stops generating multimedia data for the input manager of the third processing node.

4. The method according to claim 2, wherein deleting the association relationship between the input manager of the third processing node and the output manager of the first upstream node comprises:
deleting the association relationship between the input manager of the third processing node and the output manager of the first upstream node when no target processing task exists, the target processing task being a processing task being executed by the first upstream node and used for generating multimedia data for the input manager of the third processing node.

5. The method according to claim 2, wherein deleting the association relationship between the input manager of the third processing node and the output manager of the first upstream node comprises:
deleting the association relationship between the input manager of the third processing node and the output manager of the first upstream node when it is detected that no fourth multimedia data exists in the input manager of the third processing node.

6. The method according to claim 2, wherein deleting the association relationship between the input manager of the third processing node and the output manager of the first upstream node comprises:
generating a second processing task when it is detected that fourth multimedia data exists in the input manager of the third processing node, the second processing task comprising the fourth multimedia data; and
deleting the association relationship between the input manager of the third processing node and the output manager of the first upstream node.

7. The method according to claim 2, wherein deleting the association relationship between the output manager of the third processing node and the input manager of the first downstream node comprises:
deleting the association relationship between the output manager of the third processing node and the input manager of the first downstream node when no multimedia data exists in the input manager of the third processing node, and/or when no processing task being executed by the third processing node exists.

8. The method according to claim 2, wherein when the third processing node has the first upstream node and the first downstream node, the method further comprises:
after the two types of association relationships are deleted, if the first upstream node does not have a downstream node, and/or if the first downstream node does not have an upstream node, establishing an association relationship between the output manager of the first upstream node and the input manager of the first downstream node.

9. The method according to claim 1, further comprising:
determining a fourth processing node to be added and second adjacent nodes of the fourth processing node, the second adjacent nodes comprising a second upstream node and/or a second downstream node, and the second upstream node and the second downstream node being existing processing nodes in the processing system;
establishing an association relationship between an output manager of the second upstream node and an input manager of the fourth processing node; and/or, establishing an association relationship between an output manager of the fourth processing node and an input manager of the second downstream node.

10. The method according to claim 1, wherein the processing task of each processing node comprises at least one of following information: identifier information of the processing node, multimedia data input to the input manager of the processing node, multimedia data output to the output manager of the processing node, and generation time of the processing task.

11. (canceled)

12. An electronic device, applied to a processing system for the multimedia data, wherein the processing system comprises at least two processing nodes arranged in a sequential order; each processing node corresponding to an input manager and an output manager; two adjacent processing nodes being an upstream node and a downstream node respectively; an output manager of the upstream node and an input manager of the downstream node having an association relationship; the upstream node generating multimedia data for the downstream node, the electronic device comprising: at least one processor and a memory,
the memory storing computer-executable instructions; and
the at least one processor executing the computer-executable instructions stored in the memory to cause the electronic device to:
generate a first processing task when first multimedia data exists in a first input manager of a first processing node, wherein the first processing task comprises the first multimedia data;
call the first processing node to execute the first processing task to obtain second multimedia data, the second multimedia data being data obtained by processing the first multimedia data in the first processing task; and
write the second multimedia data into a second input manager of at least one second processing node, the second input manager being an input manager associated with a first output manager of the first processing node.

13. (canceled)

14. A computer program product, applied to a processing system for the multimedia data, wherein the processing system comprises at least two processing nodes arranged in a sequential order; each processing node corresponding to an input manager and an output manager; two adjacent processing nodes being an upstream node and a downstream node respectively; an output manager of the upstream node and an input manager of the downstream node having an association relationship; the upstream node generating multimedia data for the downstream node, the computer program product comprising: a computer program, wherein the computer program is configured to:
generate a first processing task when first multimedia data exists in a first input manager of a first processing node, wherein the first processing task comprises the first multimedia data;
call the first processing node to execute the first processing task to obtain second multimedia data, the second multimedia data being data obtained by processing the first multimedia data in the first processing task; and
write the second multimedia data into a second input manager of at least one second processing node, the second input manager being an input manager associated with a first output manager of the first processing node.

15. (canceled)

16. The electronic device according to claim 12, wherein the instructions further comprise instructions to cause the electronic device to:
determine a third processing node to be deleted in the processing system and a first adjacent node to the third processing node, wherein the first adjacent node comprises a first upstream node and/or a first downstream node; and
delete an association relationship between an input manager of the third processing node and an output manager of the first upstream node; and/or, deleting an association relationship between an output manager of the third processing node and an input manager of the first downstream node.

17. The electronic device according to claim 16, wherein before the electronic device is caused to delete the association relationship between the input manager of the third processing node and the output manager of the first upstream node, the instructions further comprise instructions to cause the electronic device to:
set a first label in the output manager of the first upstream node, the first label being used for indicating that a processing task of the first upstream node stops generating multimedia data for the input manager of the third processing node.

18. The electronic device according to claim 16, wherein the instructions to cause the electronic device to delete the association relationship between the input manager of the third processing node and the output manager of the first upstream node comprise the instructions to cause the electronic device to:
delete the association relationship between the input manager of the third processing node and the output manager of the first upstream node when no target processing task exists, the target processing task being a processing task being executed by the first upstream node and used for generating multimedia data for the input manager of the third processing node.

19. The electronic device according to claim 16, wherein the instructions to cause the electronic device to delete the association relationship between the input manager of the third processing node and the output manager of the first upstream node comprise instructions to cause the electronic device to:
delete the association relationship between the input manager of the third processing node and the output manager of the first upstream node when it is detected that no fourth multimedia data exists in the input manager of the third processing node.

20. The electronic device according to claim 16, wherein the instructions to cause the electronic device to delete the association relationship between the input manager of the third processing node and the output manager of the first upstream node comprise instructions to cause the electronic device to:
generate a second processing task when it is detected that fourth multimedia data exists in the input manager of the third processing node, the second processing task comprising the fourth multimedia data; and
delete the association relationship between the input manager of the third processing node and the output manager of the first upstream node.

21. The electronic device according to claim 16, wherein the instructions to cause the electronic device to delete the association relationship between the output manager of the third processing node and the input manager of the first downstream node comprise instructions to cause the electronic device to:
delete the association relationship between the output manager of the third processing node and the input manager of the first downstream node when no multimedia data exists in the input manager of the third processing node, and/or when no processing task being executed by the third processing node exists.

22. The electronic device according to claim 12, wherein when the third processing node has the first upstream node and the first downstream node, the instructions further comprise instructions to cause the electronic device to:
after the two types of association relationships are deleted, if the first upstream node does not have a downstream node, and/or if the first downstream node does not have an upstream node, establish an association relationship between the output manager of the first upstream node and the input manager of the first downstream node.

23. The electronic device according to claim 12, wherein the instructions further comprise instructions to cause the electronic device to:
determining a fourth processing node to be added and second adjacent nodes of the fourth processing node, the second adjacent nodes comprising a second upstream node and/or a second downstream node, and the second upstream node and the second downstream node being existing processing nodes in the processing system;
establishing an association relationship between an output manager of the second upstream node and an input manager of the fourth processing node; and/or, establishing an association relationship between an output manager of the fourth processing node and an input manager of the second downstream node.
